(19) United States
(12) Patent Application Publication
(10) Pub. No.: US 2005/0274665 A1
(43) Pub. Date: Dec. 15, 2005

(54) Capillary membrane and device for production thereof

(76) Inventors: Klaus Heilmann, St.Wendef (DE); Torsten Keller, Harmeskell (DE); Jens-Holger Stahl, Marpingen (DE)

Correspondence Address: JACOBSON HOLMAN PLLC, 400 SEVENTH STREET N.W., SUITE 600, WASHINGTON, DC, 20004, US

(21) Appl. No.: 10/505,876

(22) PCT Filed: Mar. 6, 2003
(86) PCT No.: PCT/EP03/02313

§ 371 Date: Sep. 3, 2004

(30) Foreign Application Priority Data
Mar. 13, 2002 (DE) 102 11 051.4

(51) Int. Cl. C02F 1/44

(52) U.S. Cl. 210/321.8; 210/497.01; 604/348

(57) ABSTRACT

The invention relates to a capillary membrane which comprises at least two coextruded layers in a way corresponding to the solution of the invention. The invention also relates to a device for producing the coextruded multilayer capillary membrane.

The invention relates to a capillary membrane.

Capillary membranes of a wide variety of forms are already sufficiently known. They are extensively used in dialysis. To be able to construct the most compact possible dialysers while ensuring a large exchange surface, the capillary membranes should have the smallest possible diameter.

For the large-scale industrial production of capillary membranes, hollow-fibre dies are used for example. Here, the hollow-fibre membrane is produced in a precipitation spinning process. The polymers to be precipitated emerge from an annular gap of a die arrangement, while the corresponding precipitating agent flows out of a central precipitating agent bore. The already known hollow-fibre spinnerets usually comprise a basic body made of metal into which a number of bores have been made. A small tube is fitted into one of the bores and forms a precipitating agent channel for introduction of the precipitating agent. Other bores form material feed channels for a polymer, which emerges via the previously mentioned annular gap. In the production of the previously known hollow-fibre spinnerets, customary metal working processes are used. So here the die structure is created by the two die parts being fitted together, any inaccuracy, for example of the geometry of the annular space, being the cummulative result of production errors during the production of the basic body and of the tube. In addition to that there are also possible assembly errors, which can likewise lead to inaccuracy of the geometry. On account of the production process, these previously known hollow-fibre spinnerets not only have the inaccuracies mentioned. On account of their production process, they also have a minimum size, which stops the capillary membrane from being reduced in size without any restriction. Furthermore, the capillary membranes used so far in dialysis are generally produced from a specific polymer, or a polymer blend. Such membranes that are produced from a polymer or a polymer blend have specific properties, of importance in the specific application. However, the choice of material often also entails disadvantages which have to be accepted because of the properties selected.

The object of the invention is to provide capillary membranes which combine several positive properties and nevertheless produce a large exchange surface on account of the small diameter in comparatively small dialysers.

According to the invention, the object is achieved by capillary membranes which comprise at least two coextruded layers, having an outside diameter of less than 1 mm, preferably less than or equal to 0.45 mm. On account of the coextrusion of different layers, here a number of outstanding properties of different polymers can be combined with one another. The very small diameter creates a large specific exchange surface, which leads to small, lightweight dialysers.

Advantageous refinements of the invention emerge from the subclaims which follow on from the main claim. The capillary membranes may preferably consist of one of more of the following materials: polysulphone (PS), polysulphone with polyvinylpyrrolidone (PS/PVP), polyether sulphone (PES), polyether sulphone with polyvinylpyrrolidone (PES/PVP), polyetherimide (PEI), polyetherimide with polyvinylpyrrolidone (PEI/PVP), polyamide (PA), polycarbonate (PC), polystyrene (PS), polymethylmethacrylate (PMMA), polyvinylidene fluoride (PVDF), polyacrylonitrile (PAN), polyimide (PI) and/or polyurethane (PU). For example, the inner layer may comprise a combination of polysulphone and polyvinylpyrrolidone, while the outer layer consists of polysulphone. On the other hand, however, the inner layer could also consist of a combined polysulphone/polyvinylpyrrolidone with a high polymer concentration, while the outer layer consists of a combined polysulphone/polyvinylpyrrolidone with a low polymer concentration.

According to an advantageous refinement of the invention, the membrane comprises a small-pored separation layer and a large-pored carrier layer. Compared with a single-layer asymmetrical or symmetrical membrane, the permeability of such a coextruded capillary membrane comprising a number of layers is significantly improved with the same separation limit.

One of the layers may advantageously also consist of a biocompatible material, while a second layer serves as a carrier or the actual membrane.

A further particularly preferred refinement of the invention is that one of the layers serves as a membrane, while a second consists of an adsorber material. This second layer then comes into contact with the filtrate. On the basis of these examples, which are not exhaustive, it is clearly evident that, by combining the properties of two polymers, a multifunctional capillary membrane can be customized to the actual needs in each case.

The production of the capillary membrane according to the invention is made possible by a device according to Claim 6. This device according to the invention for producing a capillary membrane coextruded from two or possibly more layers has a hollow-fibre spinneret with a coextrusion die, the outside diameter of which is less than 1 mm.

Preferred refinements of the device according to the invention emerge from the subclaims 7 to 9, which follow on from Claim 6.

Accordingly, the hollow-fibre spinneret may comprise a basic body made up of three layers, the individual layers being plate-like bodies structured by means of fine pattern technology, which are joined together to form the basic body. In this case, the first plate may be used as a pre-structured plate, onto which the second, not yet structured plate is bonded. The bonded second plate is subsequently structured. The third plate, which is once again not structured, is then bonded onto this structured plate and then likewise subsequently structured.

The basic body advantageously consists of a single-crystal silicon, gallium arsenide (GaAs) or germanium.

Particularly advantageously, the hollow-fibre spinneret has a central feed channel for the precipitating agent, material feed channels for the polymeric material, a material flow smoothing zone and an annular gap for the first polymer, as well as material feed channels for the second polymeric material, a material flow smoothing zone for these further material feed channels and an annular material gap for the second polymer.

Further details and advantages of the invention are explained in more detail on the basis of an exemplary embodiment represented in the drawing, in which:

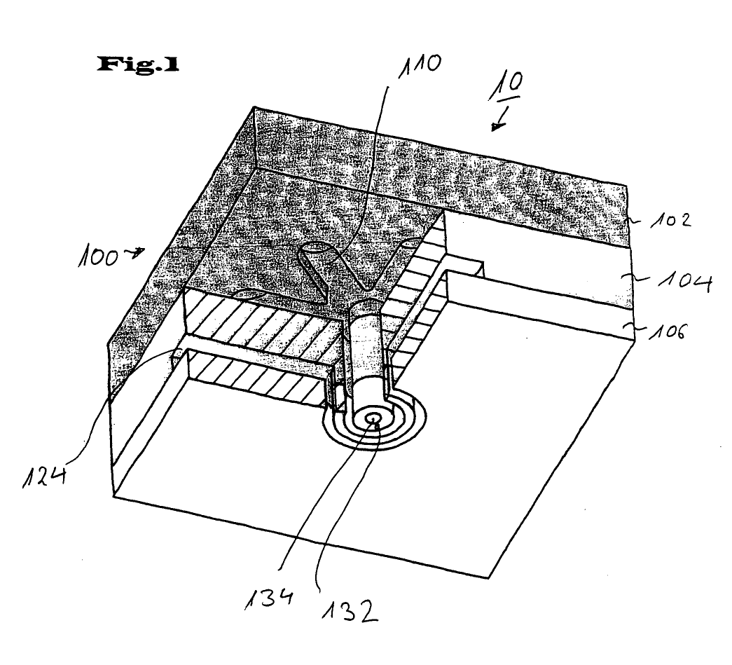

FIG. 1 shows a partly sectioned three-dimensional representation of a hollow-fibre spinneret according to a first embodiment of the invention and

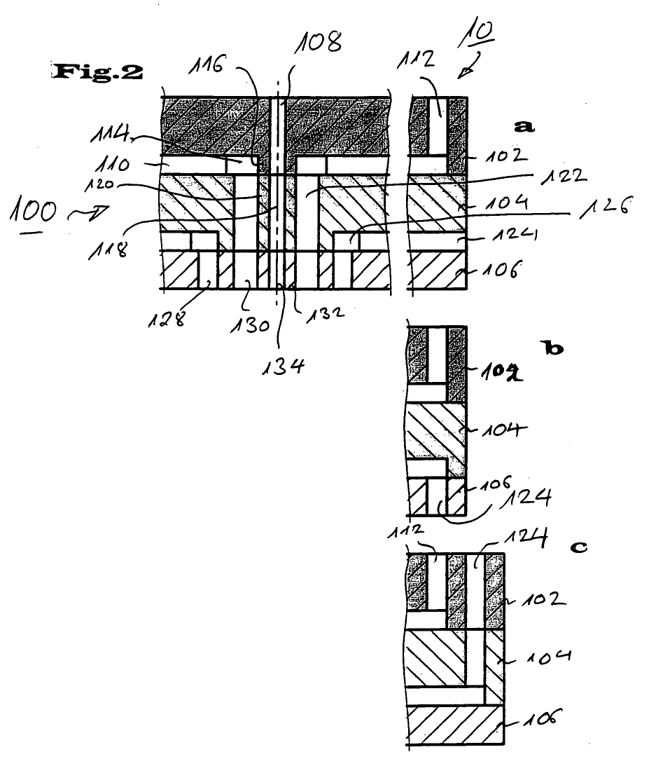

FIG. 2 shows a schematic sectional representation of the hollow-fibre spinneret according to FIG. 1, three variants of the arrangement of the material feed channels for the second polymer being shown.

A refinement of the invention is explained on the basis of FIGS. 1 and 2. Shown here is a hollow-fibre spinneret 10 for producing a hollow fibre coextruded from two layers. In this case, a hollow-fibre spinneret 10 with a basic body 100 comprising three individual plates 102, 104 and 106 is shown. The individual plates consist of single-crystal silicon. In the first plate 102, a feed channel 108 for the precipitating agent has been removed. In addition, feed channels 110, 112 for a first polymer are provided, and open out into an associated smoothing zone 114. The smoothing zone 114 surrounds a corresponding needle stump 116.

In the second plate 104, a precipitating agent bore 118 has likewise been removed, and is surrounded by a second needle stump 120 and an annular space 122. Furthermore, further feed channels 124 with an adjoining smoothing zone 126 have been removed from the second plate 104. Finally, the third plate 106 has two annular gaps 128 and 130 for the respective polymeric materials which are to be coextruded, and also a needle 132 with a precipitating agent bore 134. In the case of the variants of FIG. 2a, FIG. 2b and FIG. 2c, the feed channels 124 are differently formed in each case. While in the configurational variant according to FIG. 2a the feed channel 124 for the second polymer is merely provided in the second plate 104, in the variant according to FIG. 2b it runs both through the second plate 104 and through the third plate 106. In the configurational variant according to FIG. 2c, the feed channel 124 for the second polymer runs through the second plate 104 and the first plate 102, as represented here in FIG. 2c.

The representation according to FIG. 1 corresponds to the section according to FIG. 2a, it being clearly evident here that 8 feed channels 112 are arranged in the form of a star, while 4 feed channels 124 are arranged in the form of a cross.

In the production of hollow-fibre spinnerets by means of fine pattern technology, three round wafer slices of a diameter of 100 to 300 mm are taken as a basis. These wafers are used to produce many spinneret structures simultaneously. The individual hollow-fibre spinnerets 10 are then obtained by dividing up the wafers once processing of them has been completed. The individually separated spinnerets may each contain a single die structure, as represented here, or else a number of die structures in a die structure assembly. This is achieved by not all the die structures that are formed on the wafer being separated from one another but a number of die structures together forming a multiple die unit, which is cut out along its outer contour from the wafer.

The production of the spinnerets begins with structuring both sides of the first wafer, which receives the elements of the first plate 102 of the spinnerets. The structures are produced by a sequence of standard lithographic processes, for example masks of photoresist, SiO, Si—N or the like and standard etching processes. Among the standard etching processes, reactive ion etching (RIE), deep reactive ion etching (D-RIE) and cryo etching may be mentioned in particular. Particularly suitable are special deep etching processes such as D-RIE and cryo etching. The lithography masks for the front and rear sides must be optically aligned with one another. Then, the second wafer is bonded onto this structured wafer. All bonding processes may be used for this purpose, such as anodic bonding, direct bonding or the like. Direct bonding is particularly suitable, however, since the greatest strengths are achieved, and consequently good retention of the needles on the basic body is ensured. In the next step, the feed channels, the smoothing zone and the needle stub 120 are structured on the second plate 104, which is bonded to the first plate. For this purpose, the lithography mask must be optically aligned with the structures on the first plate. Then, the third wafer is bonded on. Again, all bonding processes, as described above, may be used for this purpose. In the next step, the die structure, comprising the annular gaps and the central bore, is formed in a two-stage etching process. In this case, in the first step, the deeper central bore and the inner annular gap are advanced, and in the second step all the structures are etched to completion. Again, the lithographic and etching processes mentioned are used, although use of the deep etching processes is even more advisable here than when processing the first wafer. In the final step, the individual spinnerets are then cut out from the wafer by suitable separating processes, such as wafer sawing and laser processing. Three-stage or multi-stage etching processes are also conceivable.

With the hollow-fibre spinneret 10 described above, coextruded hollow fibres with very small diameters can be produced with high precision from two materials.

1. Capillary membrane, characterized in that it comprises at least two coextruded layers and in that it has an outside diameter of less than 1 mm.

2. Capillary membrane according to claim 1, characterized in that it has an outside diameter of less than or equal to 0.45 mm.

3. Capillary membrane according to claim 1, characterized in that it consists of one or more of the following materials: polysulphone (PS), polysulphone with polyvinylpyrrolidone (PS/PVP), polyether sulphone (PES), polyether sulphone with polyvinylpyrrolidone (PES/PVP), polyetherimide (PEI), polyetherimide with polyvinylpyrrolidone (PEI/PVP), polyamide (PA), polycarbonate (PC), polystyrene (PS), polymethylmethacrylate (PMMA), polyvinylidene fluoride (PVDF), polyacrylonitrile (PAN), polyimide (PI) and/or polyurethane (PU).

4. Capillary membrane according to claim 1, characterized in that it comprises a small-pored separation layer and a large-pored carrier layer.

5. Capillary membrane according to claim 1, characterized in that one of the layers consists of a biocompatible material, while a second layer serves as a carrier or the actual membrane.

6. Capillary membrane according to claim 1, characterized in that one of the layers is formed as a membrane and in that a second layer consists of an adsorber material.

7. Device for producing a capillary membrane according to claim 1, characterized in that it has a hollow-fibre spinneret with a coextrusion die, the outside diameter of which is less than 1 mm.

8. Device according to claim 6, characterized in that the hollow-fibre spinneret comprises a basic body made up of three layers, the individual layers being plate-like bodies structured by means of fine pattern technology, which are joined together to form the basic body.

9. Device according to claim 6, characterized in that the base plate consists of single-crystal silicon, gallium arsenide (GaAs) or germanium.

10. Device according to claim 6, characterized in that the hollow-fibre spinneret has a central feed channel for the precipitating agent, material feed channels, a material flow smoothing zone and an annular gap for the first polymer, as well as material feed channels, a material flow smoothing zone and an annular material gap for the second polymer.

11. Capillary membrane according to claim 1, characterized in that it comprises three, four or more coextruded layers.
